(19) United States
(12) Patent Application Publication
(10) Pub. No.: US 2019/0060914 A1
(43) Pub. Date: Feb. 28, 2019

(54) METHOD AND APPARATUS FOR CENTRIFUGAL CONCENTRATION USING VIBRATORY SURFACES AND ROTOR BOWL FOR USE THEREIN

(71) Applicant: SEPRO MINERAL SYSTEMS CORP., Langley, BC (CA)

(72) Inventors: Steven Alexander MCALISTER, Abbotsford, BC (CA); Jonas Hendrik BOEHNKE, Langley, BC (CA)

(21) Appl. No.: 16/079,899

(22) PCT Filed: Feb. 24, 2017
(86) PCT No.: PCT/CA2017/050239

§ 371 Date: Aug. 24, 2018

Related U.S. Application Data
(60) Provisional application No. 62/299,645, filed on Feb. 25, 2016.

(51) Int. Cl. B04B 3/06; B04B 1/02; B01D 21/26; B01D 21/28

(52) U.S. Cl. CPC B04B 3/06; B01D 21/283; B01D 21/262; B04B 1/02

(57) ABSTRACT

A rotor bowl for use in a centrifugal concentrator for separating particulate material of higher specific gravity from a liquid slurry comprising a liquid and particulate material of different specific gravities, wherein the inner surface of the rotor bowl has an outwardly inclined migration surface and a capture zone above the migration surface, wherein the capture zone has a generally vertical annular wall located radially outwardly of the migration zone, and the generally vertical annular wall has a vibratory surface adapted to be selectively vibrated to thereby stratify particulate material or slurry located in contact with or adjacent to the vibratory surface within the capture zone to thereby permit the heavier concentrate to accumulate in the area closest to the wall of the capture zone. The vibratory surface may be the continuous inner liner of the capture zone, or separate vibrating surfaces may be provided on the surface of the inner liner in the capture zone.

The vibratory motion may be provided by one or more vibrators mounted radially outwardly of each vibratory surface. The rotor bowl may also comprise a plurality of springs mounted on the outer periphery of the vibrators and which are each biased to bear against the outer surface of a vibrator to offset centrifugal force so that each vibrator is kept in contact with the vibrating surface during rotation of the hollow bowl.

### REFERENCE TO RELATED APPLICATIONS

The present application claims the benefits, under 35 U.S.C. § 119(e), of U.S. Provisional Application Ser. No. 62/299,645 filed Feb. 25, 2016 entitled “Method and Apparatus for Centrifugal Concentration Using Vibratory Surfaces” which is incorporated herein by this reference.

### TECHNICAL FIELD

The present invention relates to centrifugal concentrators of the rotating bowl type for the separation and recovery of particulate solids of higher specific gravity, such as gold, from a slurry containing such particulate solids as well as particulate solids of a lower specific gravity and liquid.

### BACKGROUND

The problem of separating particles of high density such as precious metals from tailings and other slurry streams has attracted a great many attempted solutions. The problem is that of separating small particles of higher density from a slurry containing water and particles of lower density such as sand. One approach has been to use the centrifugal force created in a rotating bowl to separate the high density particles from the lower density slurry. One method of using a rotating bowl for this purpose involved placing obstructions such as ribs in the path of the rotating slurry to trap the heavier particles. However where the slurry contains fine, dense particles such as magnetite, the grooves or depressions designed to retain the concentrate rapidly pack with the unwanted fine particles.

The problem of packing has been addressed by the centrifugal concentrator which is the subject of U.S. Pat. No. 4,824,431 (McAlister) which is incorporated herein by this reference. In that centrifugal concentrator, there are no obstacles to the flow of the slurry in the rotating drum. The slurry is delivered to the vicinity of the bottom of the rotating drum and travels up the smooth interior surface of the drum. The interior surface has three continuous zones: an outwardly inclined migration zone, a generally vertical retention zone above the migration zone, and an inwardly-inclined lip zone above the retention zone. The respective lengths and inclinations of the zones are selected to produce flow conditions in which less dense particles are expelled from the drum while denser particles migrate to and are retained in the retention zone. The result is that an enriched layer of concentrate accumulates in the retention zone without the use of ridges or grooves which may become packed.

A second approach to the packing problem in centrifugal concentrators is that disclosed in Australian Patent no. 22,055/35 (MacNicol), complete specification published 23 Apr. 1936. FIG. 1 of that patent discloses a centrifugal concentrator in which the entire inner wall of the rotating bowl is provided with a plurality of annular riffles and a plurality of orifices arranged at the deepest point between the riffles. Water under pressure is supplied to the orifices through a supply and pressure jacket around the bowl. The flow of liquid through the orifices causes the particles caught in the riffles to be agitated and allows the heavier particles to penetrate to the wall of the bowl.

The present applicant has also disclosed in CA2149978, which is incorporated herein by this reference, a concentrator which combines features of the MacNicol and McAlister types for separating particulate material of higher specific gravity from a liquid slurry comprising a liquid and particulate material of different specific gravities. It has a capture zone which is fluidized from a source of liquid under pressure located radially outwardly of the capture zone. Centrifugal concentrators of the fluidizing bed approach of Australian Patent no. 22,055/35 have a number of disadvantages. Since a large volume of water is required to supply the water jacket to fluidize the wall of the bowl, concentrators of this type consume a good deal of water. The added water consumption adds to the cost of operation and disposal of the waste slurry output, and in some cases such as grinding circuits can have a negative impact on the overall system. Due to the addition of the fluidizing water to the input slurry, the capacity of the bowl to process the input slurry is reduced, and more energy is required to rotate the added water required for the fluidization. The addition of internal ridges also adds to the concentrator weight. There is therefore a need for a centrifugal concentrator which has the advantages of both the McAlister and MacNicol-type centrifugal concentrators, but which does not use water and requires less energy to operate than the MacNicol-type concentrator.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

There is provided therefore according to one embodiment, a rotor bowl for use in a centrifugal concentrator for separating particulate material of higher specific gravity from a liquid slurry comprising a liquid and particulate material of different specific gravities, the rotor bowl comprising an open end, a substantially closed end and an inner surface; wherein the inner surface of the rotor bowl comprises an outwardly inclined migration surface and a capture zone above the migration surface, wherein the capture zone comprises a generally vertical annular wall located radially outwardly of the migration zone, and the generally vertical annular wall comprises a vibratory surface adapted to be selectively vibrated to thereby stratify particulate material or slurry located in contact with or adjacent to the vibratory surface within the capture zone to thereby permit the heavier concentrate to accumulate in the area closest to the wall of the capture zone. The vibratory surface may be the continuous inner liner of the capture zone, or separate vibrating surfaces may be provided on the surface of the inner liner in the capture zone. The vibratory motion may be provided by one or more vibrators mounted radially outwardly of each vibratory surface. The rotor bowl may also comprise a plurality of springs mounted on the outer periphery of the vibrators and which are each biased to bear against the outer surface of a vibrator to offset centrifugal force so that each vibrator is kept in contact with the vibrating surface during rotation of the hollow bowl.

According to further embodiments, a centrifugal concentrator incorporating the foregoing rotor bowl is provided and a method of using same.

In addition to the exemplary aspects and embodiments described above, further aspects and embodiments will become apparent by reference to the drawings and by study of the following detailed descriptions.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 is a perspective view of the prior art concentrator as disclosed in CA 2149978.

FIG. 2 is a cross-section of the prior art concentrator of FIG. 1 taken along lines 4-4 with the drive assembly removed and the flushing manifold slightly repositioned for ease of illustration.

FIG. 3 is a perspective view of an embodiment of the vibrating rotor bowl assembly for the centrifuge of the invention.

FIG. 4 is a top view of the rotor bowl assembly shown in FIG. 3.

FIG. 5 is a cross-section view taken along lines A-A of FIG. 4.

FIG. 6 is a cross-section view of a second embodiment of the vibrating rotor bowl assembly for the centrifugal concentrator of the invention lines taken along lines A-A of FIG. 15.

FIG. 7 is a cross-section view of the vibrating rotor bowl assembly for the embodiment of the invention shown in FIG. 6, taken along lines B-B of FIG. 15.

FIG. 8 is an isometric view of the vibrating rotor bowl assembly shown in FIG. 6.

FIG. 9 is an isometric view of the vibrating rotor bowl assembly for the centrifugal concentrator of the invention as shown in FIG. 8, with the casing in phantom outline for ease of illustration.

FIG. 10 is a cross-section taken along lines 10-10 of FIG. 9.

FIG. 11 is an isometric view of the vibrating rotor bowl assembly for the centrifuge of the invention as shown in FIG. 8 with the casing removed.

FIG. 12 is a cross-section taken along lines 10-10 of FIG. 9 illustrating the capture of target particles from the slurry.

FIG. 13 is a cross-sectional detail of a vibrator-to-vibrating plate connection as shown in FIG. 12 and illustrating a bed of captured target particles from the slurry.

FIG. 14 is an exploded perspective view of the vibrating rotor bowl assembly for the embodiment of the invention shown in FIG. 6.

FIG. 15 is a top view of the rotor bowl assembly shown in FIG. 14.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

The term “stratify” is used herein to mean the act of sorting the target particulate material by specific gravity or density in the capture zone described below, in the radial direction due to centrifugal force from rotation of the rotor. Such stratification may be achieved as described below all or in part by transmission of vibration or shaking to relatively free-flowing particles in the capture zone of the rotor which are already in the nature of a bed, or are closer to a slurry in nature. Or it may be achieved by the application of vibratory forces or shaking in combination with fluidization using fluid or gas injection, or in the case of a solidified bed in the capture zone of the rotor by using more intense vibration to cause liquefaction.

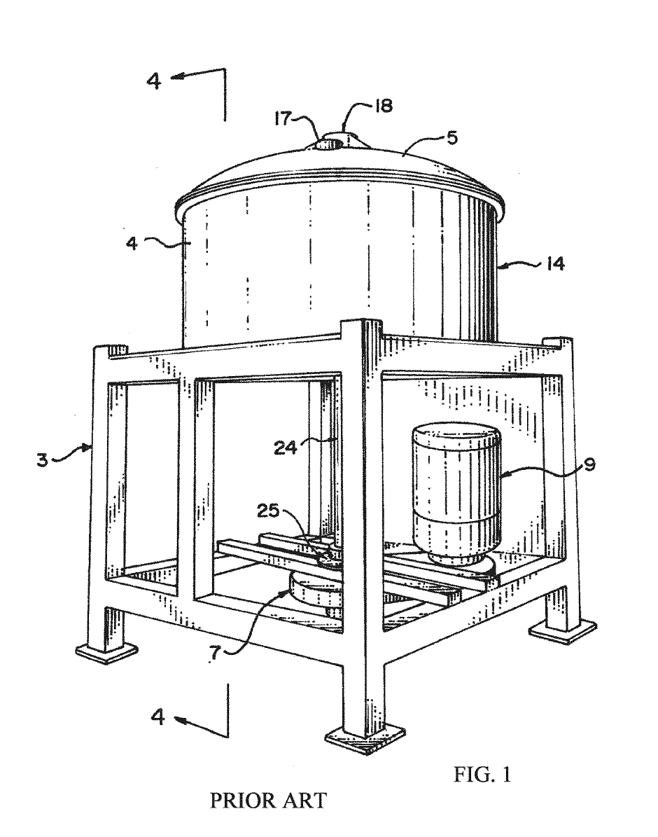

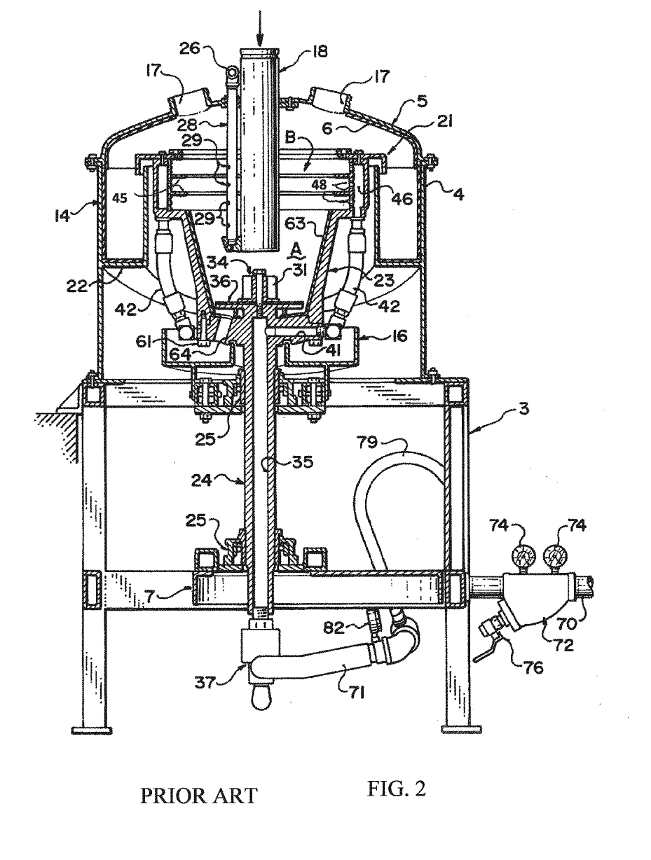

A prior art centrifugal concentrator as disclosed in CA2149978 is shown in FIGS. 1 and 2. It has a frame 3, a shroud 4 consisting of shroud lid 5 and tailings launder 14, and drive motor 9. The frame is constructed of hollow steel sections which are sealed to provide water storage. The shroud lid 5 has openings for a slurry feed pipe 18 and inspection ports 17 sealed by removable plugs, and an inner lining 6 of a wear resistant material such as LINATEX™ or a natural rubber. The flange of shroud lid 5 is bolted to the upper flange of tailings launder 14. Tailings launder 14 is provided with a tailings discharge port. A concentrate launder 16 with a concentrate discharge port is also provided. The floor of launder 14 is sloped downwardly to assist in a smooth outward flow of the discharge. Rotor 21 is formed of rotor bowl 23 and hollow rotor shaft 24. The rotor 21 is mounted for rotation in the frame 3 by bearing assemblies 25. The inner surface of rotor bowl 23 forms a migration zone A and a capture zone B, which cause the denser, target particles from the slurry flow to be concentrated in the capture zone B. The rotor shaft 24 is driven by a belt, located in belt guard 7 and driven by electric motor 9. An impeller 34 is provided on the center of baffle 36, which is raised above and secured to the floor of bowl 23. Impeller 34 has a plurality of upstanding vanes 31 to assist in the rotation of the slurry.

An external pipe 26 provides water under pressure from the frame 3 to a hollow flushing manifold 28 secured to feed pipe 18 and provided with holes 29. A plumbing assembly supplies water under pressure to a rotating union 37 through which the water passes to the hollow interior 35 of rotor shaft 24 from where it passes into radially extending passages 41 and thence into supply hoses 42 which carry the water under pressure to annular chamber 46. Rotor bowl 23 is formed of a lower bowl section which is bolted by bolts 61 to the upper sloping bowl section. Rotor bowl 23 has four concentrate outlets 64. The inner surface of bowl 23 and the upper surface of baffle 36 have a lining 63 of a wear resistant material such as LINATEX™ or a natural rubber. Rotor bowl 23 is fixed to rotor shaft 24. The vertical wall of capture zone B has a plurality of holes 48 formed therethrough in the areas between ribs 45. Holes 48 communicate with hollow chamber 46 which in turn is supplied with water under pressure through the supply hoses 42. The tops of the ribs follow generally the slope of the migration zone A if it were extended. Water is supplied to frame 3 through pipe 70, via water filter 72 having pressure gauges 74. External release valve 76 permits water to be released to clean filter 72. Pipe 71, with pressure gauge 82, supplies water from frame 3 to rotating union 37. A manual lever and valve permits bypass pipe 79 to be manually shut.

In operation, motor 9 is activated to rotate the rotor shaft 24. The slurry feed is introduced to the spinning rotor through feed pipe 18. Centrifugal forces cause the slurry to climb up the migration zone A on inner surface 63 of the rotor bowl section past capture zone B before being expelled into tailings launder 14 and thence out of the machine through a discharge port. The areas between the ribs 45 in capture area B are initially empty prior to introduction of the slurry. They rapidly fill with solids as the slurry is introduced. As the process advances, the heavier particles accumulate in these areas. The flow of water under pressure through the holes 48 from chamber 46 causes the particles to be agitated and permits the heavier concentrate to accumulate in the area closest to the wall of capture zone B. Once there has been a sufficient accumulation of concentrate, the feed slurry is shut off, the rotation of the bowl slows to a very gradual rotation, water is sprayed out through manifold 28 and the concentrate flows around baffle 36, out outlets 64 into concentrate launder 16 from where it is collected. In order to avoid fine slurry particles penetrating into chamber 46 through holes 48, which would necessitate cleaning of chamber 46, and to assist in emptying the rotor of concentrate when the rotor is slowly rotating in the rinse cycle, water is constantly supplied into chamber 46 under pressure, even during the rinse cycle.

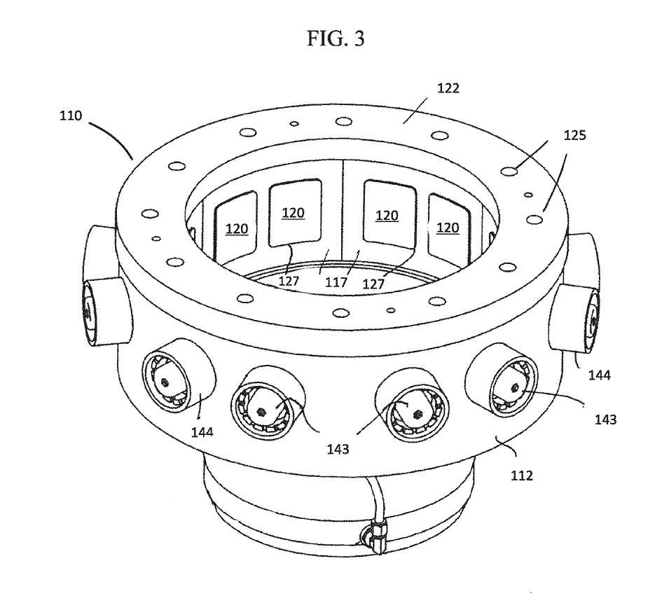

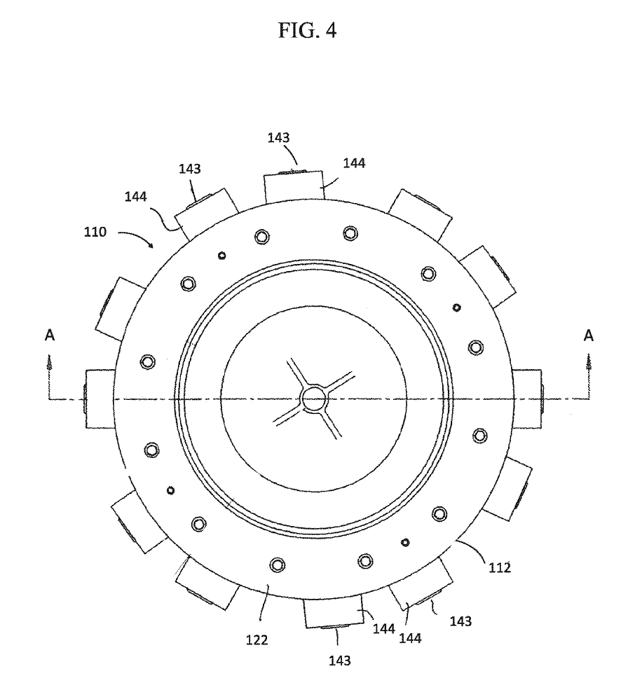

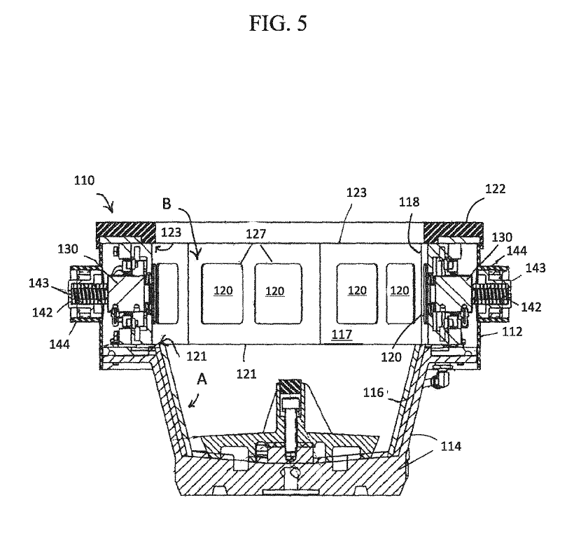

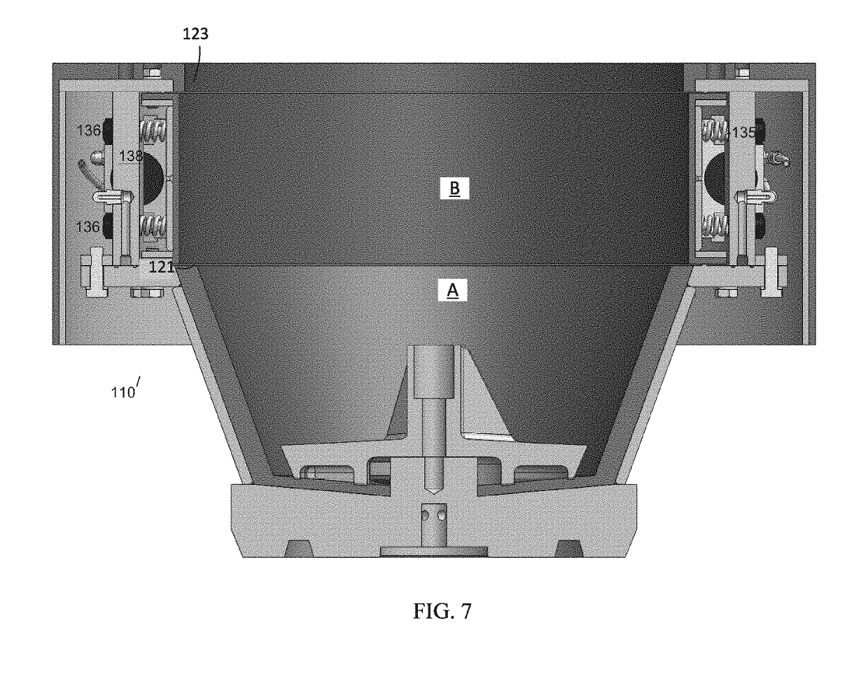

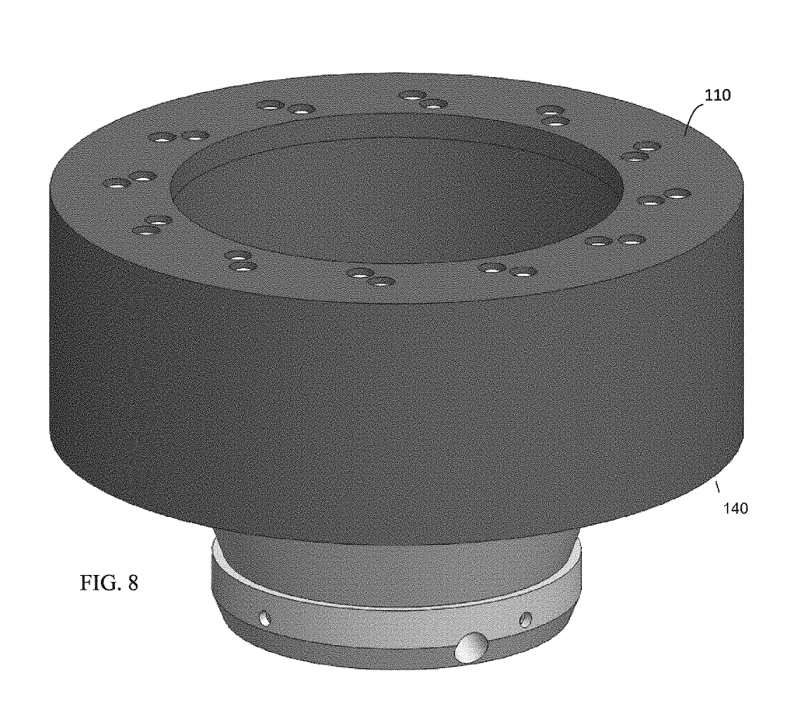

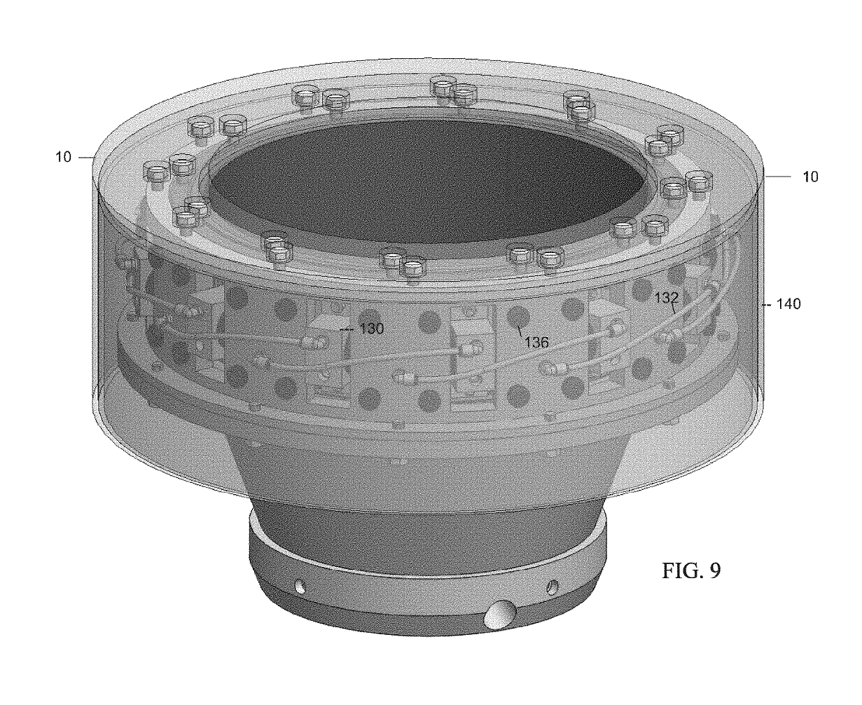

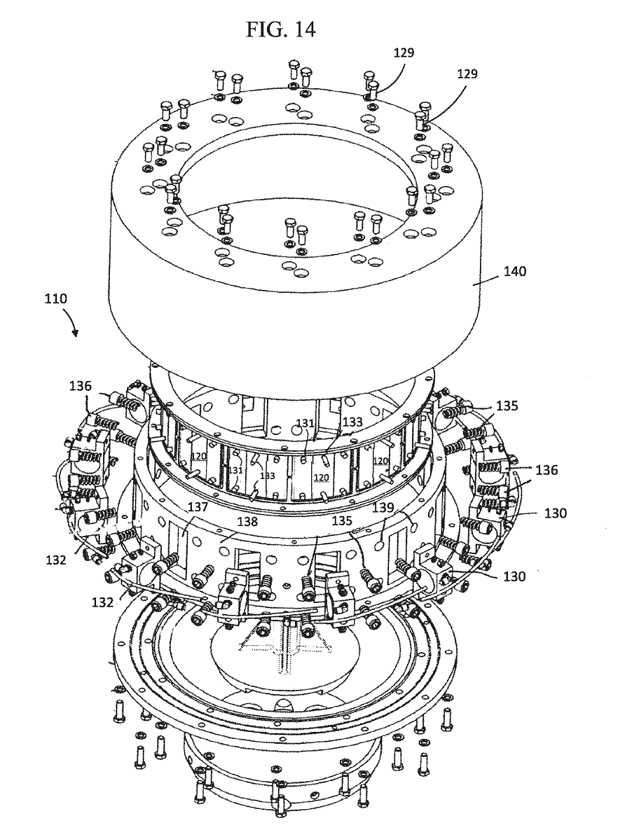

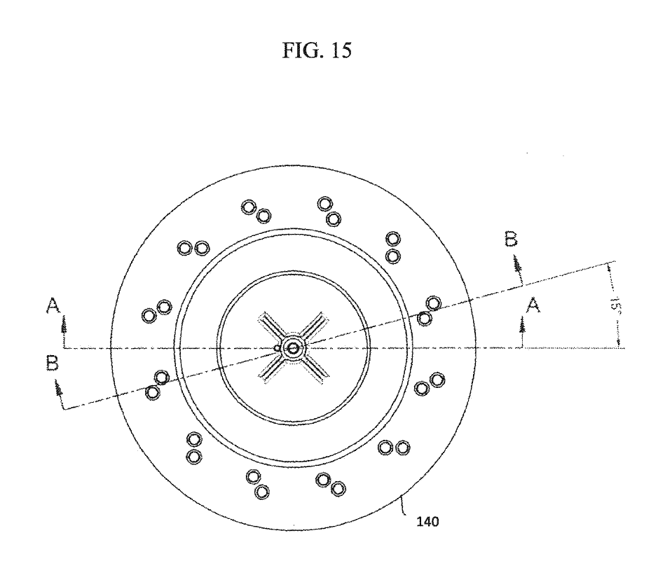

The present improvement, shown in FIG. 3-15, provides a rotor bowl assembly for the concentrator described above which replaces the need for fluidizing water with vibrating surfaces. A first embodiment of rotor bowl 110 is illustrated in FIG. 3-5 shown in isolation for purposes of illustration, with outer support ring 112 in place. Rotor bowl 110 has a sloped lower bowl section 114 with liner 116, forming the migration zone A. Capture zone B has a vertical wall 118, the radially inward surface of which is formed of a lining 117 of a wear resistant material such as rubber in which are provided a plurality of vibrating plates 120. Discharge lip ring 122 is secured to bowl 110 by a plurality of screws or nuts 129 (FIG. 14) threaded into an array of holes or slots 125, or other securing means thereby forming the upper edge 123 of the capture zone B. The lower edge 121 of capture zone B is formed by the upper edge of sloped lower bowl section 114 and liner 116.

Vibrating plates 120 are preferably steel plates. The radially inner surfaces of vibrating plates 120 are preferably smooth steel. The plates 120 are attached to the lining 117 to form a continuous inner surface but plates 120 may move radially in relation to the lining 117. They may be glued to the liner by an appropriate adhesive along the outer surface of their outer edges 127. In the embodiment shown in FIG. 3-5, the vibrating plates 120 sit on top of lining 117 to directly contact the slurry in the interior of the rotor bowl.

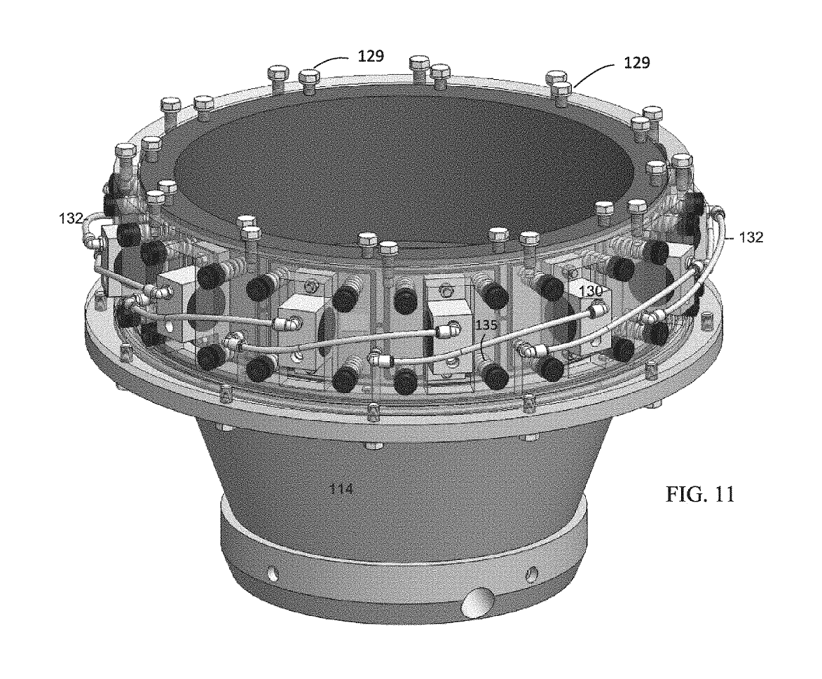

Contacting the rear surface of each plate 120 is a vibrator 130 which extend through openings in lining 117. These are preferably pneumatic turbine vibrators. Compressed air is provided to each vibrator by pneumatic lines 132 (FIG. 11). Alternatively they may be hydraulically or piezo-electrically powered. The frequency and magnitude of vibration is selected based on the size and density of particles in the slurry and the viscosity of the slurry and can range from low frequency to ultrasonic. The direction of the plane of vibration of each vibrator may also varied from horizontal (radial), to vertical or to some other intermediate angle or orbital.

In the embodiment shown in FIG. 3-5, springs 142 are mounted within spring vibrator supports 143, housed within cylinders 144 on the outer periphery of the vibrators 130 and which bear against the outer surface of the vibrators 130 to offset centrifugal force so that the vibrators are kept in contact with the vibrating plates 120 during the high speed rotation of the rotor 110.

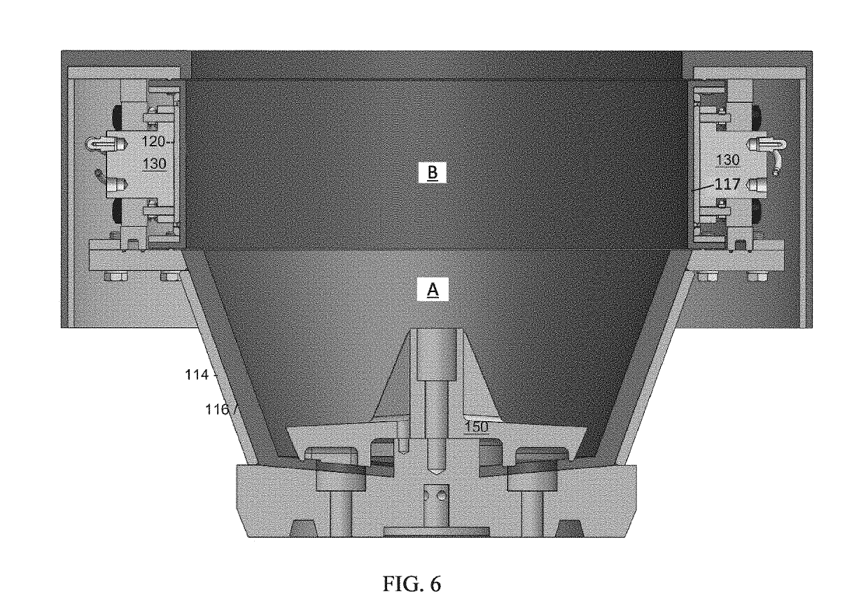

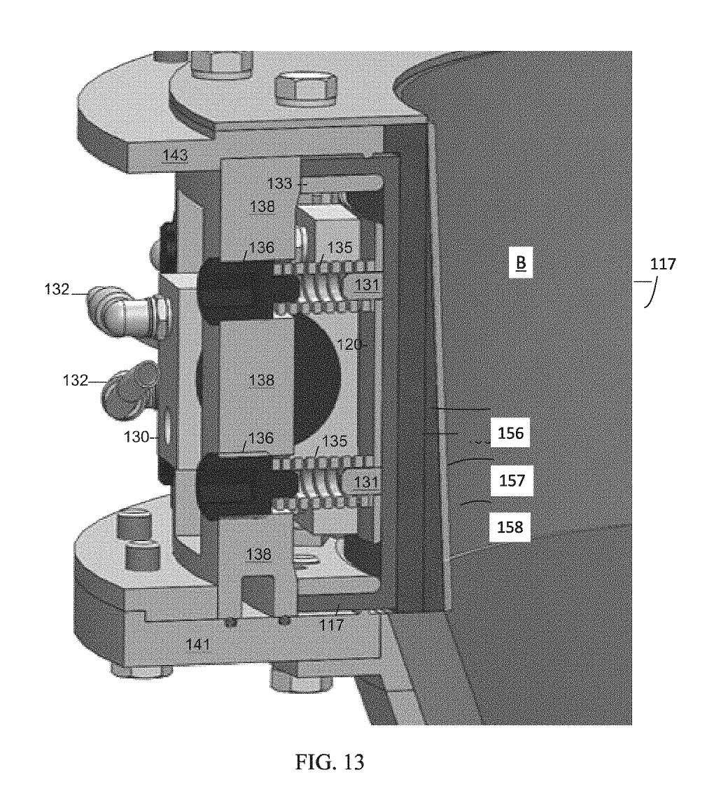

In the embodiment shown in FIG. 6-15, specifically with reference to the embodiment shown in FIG. 6 and FIG. 13, lining 117 forms a continuous rubber surface in the capture zone B which is in contact with the slurry. The vibrating plates 120 contact or are glued to the radially outer surface of lining 117. Each vibrator 130 is bolted directly to the rear of the associated vibrating plate 120 by bolts 133. In this embodiment, vibrators 130 directly activate vibrating plates 120 and do not extend through the lining 117 and do not contact the slurry in the interior of the rotor bowl. The vibrators 130 extend through openings 137 in outer ring 138 (FIG. 14). Outer ring 138 is fixed to rotor bowl 114 at its upper and lower edges by bolts to rings 141, 143 (FIG. 13). The springs 135 support the vibrating plates 120, vibrators 130 and interior rubber surface of lining 117 so that the entire assembly has minimal deflection under centrifugal force during operation. Springs 135 extend through holes 139 in outer ring 138 (FIG. 14). The springs 135 are each supported at their radially inner end by a post 131 on the vibrating plate 120. The radially outer end of each spring 135 is preloaded by a bolt 136 threaded into hole 139 from the outside of the outer ring 138. Casing 140 protects the vibrators from the environment of the concentrator.

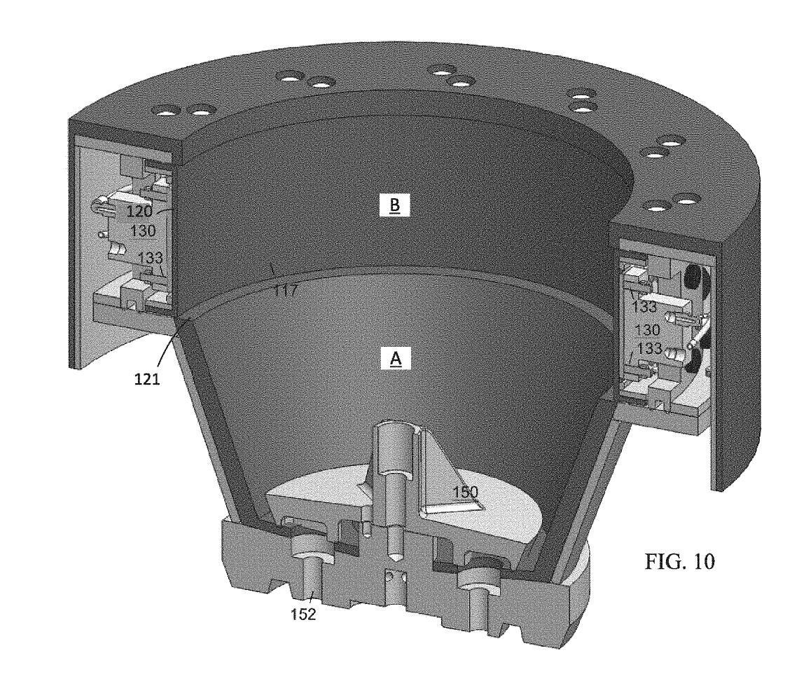

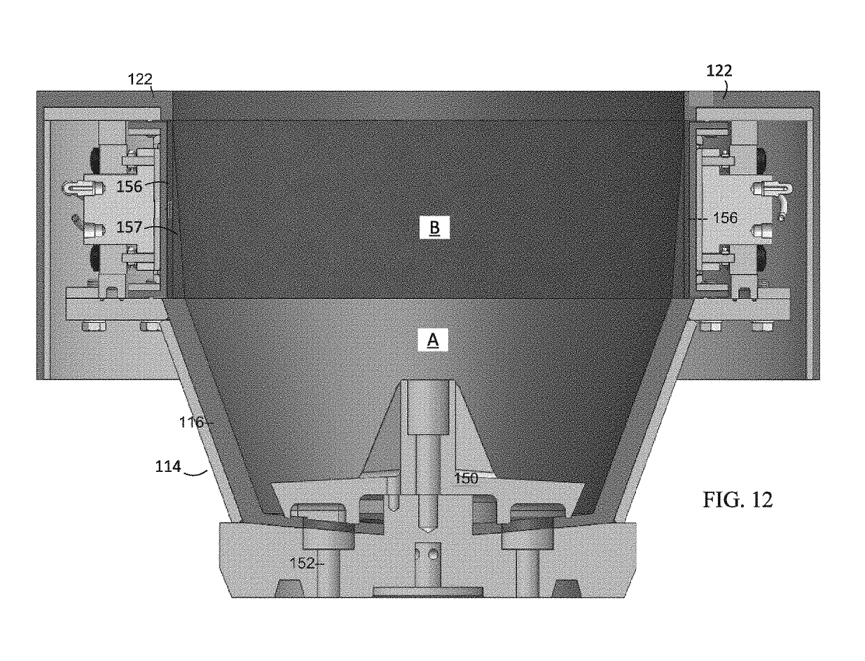

In operation, the turbine vibrators are turned on prior to commencing rotation of the rotor bowl 110. Rotation of the bowl 110 is then commenced and the slurry is introduced to the interior of the bowl in the usual way. The depth of the lip ring 122 is adjusted in advance by selection of the inner radius of the lip ring 122 to determine the depth of the target bed 156 shown in FIGS. 12 and 13. The vibration of the vibratory plates 120 vibrates the particulate slurry in the vicinity of capture zone B to permit the heavier particles of concentrate to accumulate in the area 156 closest to the wall of capture zone B while lighter slurry 158 is expelled over intermediate bed 157. Once there has been a sufficient accumulation of target concentrate in bed 156, the feed slurry is shut off, the rotation of the bowl slows to a very gradual rotation, water is sprayed from a rinse manifold into the capture zone B to remove the target concentrate and the recovered concentrate then flows around the baffle 150, out outlets 152 (FIG. 10), into a concentrate launder from where it is collected.

As noted above, control means may be provided to vary the frequency and magnitude of vibration, which is selected based on the size and density of particles in the slurry and the viscosity of the slurry and can range from low frequency to ultrasonic. Where the slurry is highly viscous and/or the particle bed in the capture zone approaches the properties of a solid with resistance to flow, a high frequency and/or magnitude of vibration may be required to liquefy the particle bed, or there may be auxiliary fluidization of the particle bed using injected fluid or gas. Control means in combination with electric servo motors may also be provided to vary the orientation of the vibratory motors to vary the direction of vibration from horizontal (radial), to vertical or some other angle, or orbital.

While a number of exemplary aspects and embodiments have been discussed above, those of skill in the art will recognize certain modifications, permutations, additions and sub-combinations thereof. It is therefore intended that the invention be interpreted to include all such modifications, permutations, additions and sub-combinations as are consistent with the broadest interpretation of the specification as a whole.

1. A centrifugal concentrator for separating particulate material of higher specific gravity from a liquid slurry comprising a liquid and particulate material of different specific gravities, said concentrator comprising:
(a) a hollow drum having an open end, a substantially closed end and an inner surface;
(b) means for rotatably supporting said hollow drum for rotation about a vertical axis;
(c) drive means for rotating said hollow drum about said axis;
(d) material supply means to deliver said liquid slurry into the end of said drum spaced from said open end;
wherein said inner surface of said hollow drum comprises an outwardly inclined migration surface and a capture zone above said migration surface, wherein said capture zone comprises a generally vertical annular wall located radially outwardly of said migration surface, and said generally vertical annular wall comprises a vibratory surface adapted to be selectively vibrated to thereby stratify particulate material or slurry located in contact with or adjacent to said vibratory surface within said capture zone, said vibratory surface being provided vibratory motion by one or more vibrators mounted radially outwardly of said vibratory surface.

2. The centrifugal concentrator of claim 1 wherein said generally vertical annular wall comprises a plurality of vibratory surfaces adapted to be selectively vibrated to thereby stratify particulate material or slurry located in contact with or adjacent to said vibratory surface within said capture zone, each said plurality of vibratory surfaces provided vibratory motion by one or more vibrators mounted radially outwardly of each said plurality of vibratory surfaces.

3. The centrifugal concentrator of claim 1 wherein said generally vertical wall of said capture zone comprises a wear-resistant inner lining and a plurality of vibratory surfaces forming portions of said inner lining, each said vibratory surface being provided vibratory motion by one or more vibrators mounted radially outwardly of said each said vibratory surface.

4. The centrifugal concentrator of claim 3 wherein said plurality of vibratory surfaces each comprises a radially inwardly facing surface to contact said liquid slurry in said capture zone when said centrifugal concentrator is in operation.

5. The centrifugal concentrator of claim 3 wherein a periphery of each said vibratory surface is secured to said inner lining.

6. The centrifugal concentrator of claim 1 wherein said substantially vertical wall of said capture zone comprises a continuous wear-resistant inner lining provided vibratory motion by one or more vibrators mounted radially outwardly of said continuous inner lining.

7. The centrifugal concentrator of claim 6 wherein said inner lining comprises a radially inwardly facing surface to contact said liquid slurry in said capture zone when said centrifugal concentrator is in operation.

8. The centrifugal concentrator of claim 1 further comprising flow-obstructing means extending radially inwardly in relation to said vertical wall to form the upper boundary of said capture zone.

9. The centrifugal concentrator of claim 2 wherein each of said plurality of vibratory surfaces comprises a smooth metal surface.

10. The centrifugal concentrator of claim 1 wherein said vibrators are pneumatic and said centrifugal concentrator further comprises means for providing compressed air to each vibrator by pneumatic lines.

11. The centrifugal concentrator of claim 1 wherein said vibrators are hydraulically or piezo-electrically powered.

12. The centrifugal concentrator of claim 1 further comprising one or more springs mounted on the outer periphery of said one or more vibrators and which are each biased to bear against the outer surface of said one or more vibrators to offset centrifugal force so that said one or more vibrators are kept in contact with the vibrating surface during rotation of the hollow bowl.

13. The centrifugal concentrator of claim 1 further comprising control means for varying the frequency and magnitude of vibration of said one or more vibrators.

14. The centrifugal concentrator of claim 1 further comprising control means for varying the direction of the plane of vibration of said one or more vibrators from radial and horizontal, to vertical or other intermediate angles, or orbital.

15. A method of separating particulate material of higher specific gravity from a liquid slurry comprising a liquid and particulate material of different specific gravities, said method comprising:
a) providing a concentrator comprising:
(i) a hollow drum having an open end, a substantially closed end and an inner surface;
(ii) means for rotatably supporting said hollow drum for rotation about a vertical axis;
(iii) drive means for rotating said hollow drum about said axis;
(iv) material supply means to deliver said liquid slurry into the end of said drum spaced from said open end;
wherein said inner surface of said hollow drum comprises an outwardly inclined migration surface and a capture zone above said migration surface, wherein said capture zone comprises a generally vertical annular wall located radially outwardly of said migration surface, and said generally vertical annular wall comprises a vibratory surface, said vibratory surface being provided vibratory motion by one or more vibrators mounted radially outwardly of said vibratory surface, said vibratory surface adapted to be selectively vibrated to thereby stratify particulate material or slurry located in contact with or adjacent to said vibratory surface within said capture zone; and
b) rotating said hollow drum;
c) feeding said slurry through said material supply means;
d) selecting a frequency and magnitude of vibration of said one or more vibrators based on the size and density of particles in the slurry and the viscosity of the slurry and activating said one or more vibrators at said selected frequency and magnitude to vibrate said vibratory surface in said capture zone to agitate said slurry in said capture zone until a desired volume of target material is captured in said capture zone;
e) stopping the supply of said slurry to said hollow bowl;
f) reducing the speed of said rotation of said bowl; and
g) washing said captured material out of said capture zone.

16. The method of claim 15 further comprising the step of varying the frequency and magnitude of vibration based on the size and density of particles in the slurry and the viscosity of the slurry.

17. The method of claim 16 further comprising the step of varying the frequency from low frequency to ultrasonic.

18. The method of claim 15 further comprising the step of varying the direction of the plane of vibration of said vibratory surface from horizontal (radial), to vertical or some other intermediate angle, or orbital.

19. A rotor bowl for use in a centrifugal concentrator for separating particulate material of higher specific gravity from a liquid slurry comprising a liquid and particulate material of different specific gravities, said rotor bowl comprising an open end, a substantially closed end and an inner surface; wherein said inner surface of said rotor bowl comprises an outwardly inclined migration surface and a capture zone above said migration surface, wherein said capture zone comprises a generally vertical annular wall located radially outwardly of said migration surface, and said generally vertical annular wall comprises a vibratory surface adapted to be selectively vibrated to thereby stratify particulate material or slurry located in contact with or adjacent to said vibratory surface within said capture zone, said vibratory surface being provided vibratory motion by one or more vibrators mounted radially outwardly of said vibratory surface.

20. (canceled)

21. The rotor bowl of claim 19 wherein said substantially vertical wall of said capture zone comprises a wear-resistant inner lining and a plurality of vibratory surfaces forming portions of said inner lining, each said vibratory surface being provided vibratory motion by said one or more vibrators mounted radially outwardly of said each said vibratory surface.

22. The rotor bowl of claim 21 wherein said plurality of vibratory surfaces each comprises a radially inner surface to contact said liquid slurry in said capture zone when said centrifugal concentrator is in operation.

23. The rotor bowl of claim 22 wherein a periphery of each said vibratory surface is secured to said inner lining.

24. The rotor bowl of claim 19 wherein said substantially vertical wall of said capture zone comprises a continuous wear-resistant inner lining provided vibratory motion by said one or more vibrators mounted radially outwardly of said continuous inner lining.

25. The rotor bowl of claim 24 wherein said inner lining comprises a radially inner surface to contact said liquid slurry in said capture zone when said centrifugal concentrator is in operation.

26. The rotor bowl of claim 19 further comprising flow-obstructing means extending radially inwardly in relation to said vertical wall to form the upper boundary of said capture zone.

27. The rotor bowl of claim 22 wherein each said vibratory surface comprises a smooth metal surface.

28. The rotor bowl of claim 19 wherein said one or more vibrators are pneumatic and said centrifugal concentrator further comprises means for providing compressed air to each vibrator by pneumatic lines.

29. The rotor bowl of claim 19 wherein said one or more vibrators are hydraulically or piezo-electrically powered.

30. The rotor bowl of claim 19 further comprising one or more springs mounted on the outer periphery of said one or more vibrators and which are each biased to bear against the outer surface of said one or more vibrators to offset centrifugal force so that each of said one or more vibrators is kept in contact with said vibrating surface during rotation of the hollow bowl.

31. The rotor bowl of claim 19 further comprising means for varying the frequency and magnitude of vibration of each said one or more vibrators.

32. The rotor bowl of claim 19 further comprising means for varying the direction of the plane of vibration of each said one or more vibrators from radial and horizontal, to vertical or other intermediate angles, or orbital.
